(19) United States
(12) Patent Application Publication
(10) Pub. No.: US 2011/0170424 A1
(43) Pub. Date: Jul. 14, 2011

(54) APPARATUS AND METHODS FOR INTERFERENCE MITIGATION AND COORDINATION IN A WIRELESS NETWORK

(76) Inventor: Saeid Safavi, San Diego, CA (US)

(21) Appl. No.: 12/987,888

(22) Filed: Jan. 10, 2011

Related U.S. Application Data
(60) Provisional application No. 61/293,434, filed on Jan. 8, 2010.

(51) Int. Cl. H04L 12/26; H04W 84/02

(52) U.S. Cl. 370/242; 370/338

(57) ABSTRACT

Apparatus and methods for interference mitigation in a wireless network, such as e.g., a wireless LAN. In one embodiment, substantially centralized RF spectrum monitoring is used as a basis of enabling interference mitigation for, e.g., mobile units such as computer and smartphones within the wireless network.

### PRIORITY

This application claims priority to U.S. Provisional Patent Application Ser. No. 61/293,434 filed Jan. 8, 2010 and entitled “AN APPARATUS BASED ON CENTRALIZED RF SPECTRUM MONITORING, ENABLING INTERFERENCE MITIGATION AND COORDINATION IN A WIRELESS NETWORK”, which is incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

This disclosure relates to interference mitigation and coordination in wireless systems, such as e.g., wireless local area networks (WLANs) and cellular mobile radio systems such as GSM, WCDMA, WiMAX and LTE (long-term evolution) which deploy Picocell and or Femtocell architectures. At least some of the examples disclosed herein relate to a centralized RF spectrum sensing including interference measurement and mitigation method involving spectral sensing, communication over backbone or infrastructure network (including switch, controller, network management architecture), beam forming, MIMO, power control, MAC scheduling using a cross-layer approach all of which employed towards coordinated performance enhancement of cellular networks and WLAN networks, including enterprise and home networks in presence of interference.

### DESCRIPTION OF THE RELATED ART

Over the past decade, the wireless communications network technology has undergone tremendous evolution from voice communications-based cellular systems of the digital 2G cellular (e.g. GSM) to multi-service heterogeneous networks that can handle data and high speed multimedia in addition to voice applications (e.g. 3G cellular and beyond including WCDMA, HSPA, etc.), WiMAX, Wireless Local Area Networks (WLAN) and the future Long Term Evolution (LTE) or 4G cellular. These technologies were initially designed to serve a variety of wireless applications and coverage classes, ranging from WBAN (Wireless Body Area Networks) and WPAN (Wireless Personal Area Networks, e.g. Bluetooth), to WLAN (e.g. WiFi), WMAN (Wireless Metropolitan Area Networks such as WiMAX), all the way to WWAN (wireless wide area networks such as WCDMA and LTE).

As these new technologies evolve, the need for integration of various applications and services becomes increasingly necessary. For example today's WLAN is progressively integrated with the cellular third generation (3G) mobile communication system to improve the coverage and capacity. It is anticipated that in the near future a superposition of access networks of various architectures and topologies ranging from Pico-cellular systems (such as WPANS) to large cell sized or macro-cellular systems (such as WCDMA) covering a wide range of user applications and services. As the wireless networks evolve to support heterogeneous architectures with ubiquitous coverage, a high degree of adaptively and flexibility is required particularly in the radio access node (e.g. Access Point or Base Station).

To support large capacity and ubiquitous coverage in both indoor and outdoor environments and compensate for coverage holes, smaller cell architectures have been in introduced in the cellular networks. This includes Picocell and Femtocell architectures. A Picocell usually covers a small area, such as in-building, using a base station which is typically a low cost, small and simple device, This base station connects to the cellular base station controller or BSC that acts as a gateway to mobile switching center (MSC) and also supports handover between the Picocell base stations. Femtocells are based on a similar concept but have smaller coverage and are also known as access point bases stations as their coverage and functionality are similar to a small cellular base station, typically designed for use in a home or small business (similar to the role of access points in WLAN). A Femtocell infrastructure connects to the service provider's network via broadband (such as DSL or cable); current designs typically support 2 to 4 active mobile phones in residential locations, and 8 to 16 active mobile phones in enterprise environments. The Femtocell incorporates the functionality of a typical base station but extends it to other network node functionalities (such as gateways that connect to core network) to enable some form of self contained deployment. Femtocell architectures use the exiting unlicensed spectrum to communicate with the wireless access points (in which case require the so-called dual mode handsets) or support Femtocell-based deployment requires installation of a new access point that uses licensed spectrum (but does not need dual mode handsets).

In parallel to cellular systems, the WLAN standardization effort has undergone tremendous evolution from low rate data infrared-based communications in first generation WLANs to the high throughput OFDM radios with adaptive algorithms including MIMO. The radio channel agility and interference susceptibility along with the scarcity of wireless spectrum motivated a large body of work within the IEEE 802.11 standards to optimize the performance of WLANs. This effort, highly focused on optimization of physical (PHY) layer, resulted in a resulted in number of new methods for performance improvement of the wireless network. Among the above advancements in the PHY-based radio link techniques, various types of advanced channel coding schemes such as turbo-codes, low-density parity-check codes (LDPC) and other efficient coding schemes have been proposed for WLAN, with a very narrow margin to Shannon capacity. The combination of OFDM (orthogonal frequency division multiplexing) and MIMO (multiple input multiple output)-based multiple antenna systems in particular, has been suggested to improve the performance and throughput. Despite extending the coverage area MIMO performance is highly correlated with multipath propagation scenarios make the coverage are less predictable, while resulting in some coverage holes. Finally a control mechanism that can affect the performance of WLAN networks is the power control which is tightly coupled with both MAC and PHY layers.

In parallel to the information theory-related technologies applied to PHY-based resource allocation, MAC-based resource allocation strategies has also been improved using a handful of advanced networking techniques. In particular an important design aspect of modem WLANs is the support of quality of service or QoS in the MAC. This demand triggered a new generation of MAC protocols in the IEEE 802.11 standards. More specifically, the IEEE 802.11 MAC was initially designed for best effort services, lacked a built-in mechanism for support of the QoS required for real time services such as VoIP, HDTV, online gaming, etc. In order to provide a guaranteed QoS, a new generation of MAC termed IEEE 802.11.e was introduced (see Reference [1], which is incorporated herein by reference in its entirety). This new MAC employs a so called Hybrid Coordination Function (HFC) with two medium access mechanisms and four classes of user priorities that facilitate implementation of QoS-enabled MAC architecture.

The combination of the above technologies has enabled WLAN radios to achieve has exhausted the PHY and MAC performance enhancement tools while most of these solution cause significant increase in the power consumption of WLANs and cellular systems. In addition some of these methods have introduced significant cost and complexity to the devices. This exhaustion of performance enhancement tools resulted in the optimization paradigm shift to the scheduling and network management side. In this respect, IEEE 802 standards have initiated powerful network coordination methodologies by addressing radio resource allocation (802.11k) (see Reference [2], which is incorporated herein by reference in its entirety), and network management techniques (802.11k and 802.11v) to enhance the WLAN throughput and QoS issues. The 802.11v (see Reference [3], which is incorporated herein by reference in its entirety), in particular is targeted to address other enhancements such as RTLS (real time location services), power consumption and co-location interference.

It is interesting to note that despite the tremendous advancements in WLAN technology, the one area which is not addressed effectively is the interference mitigation methodologies. To this end, the main WLAN interference avoidance methodology is the traditional CSMA/CA (carrier sense multiple access with collision avoidance) which is a “listen-before-talk” strategy in WLAM MAC, that effectively avoids collisions in transmissions (or co-channel interference) at the price of sacrificing the throughput. Other techniques such as MIMO and local interference cancellation are also proposed, but they have limited enhancements while producing other draw-backs (such as complexity, power consumption and cost). On the other hand the MAC advancements in 802.11e to support quality of service and make the CSMA/CA more efficient did not take off due to, the implementation complexity and cost issues. At the same time however, the interference is rapidly becoming a growing problem in the WLAN and related technologies. The growing number of WLAN users, and the scarcity of spectrum on the one hand, and the demanding nature of emerging WLAN traffic (such as delay sensitive, high QoS real-time video and audio services) on the other hand, are the trends that are progressively increasing the interference level in unlicensed WLAN bands. Recently, many vendors and service providers have independently developed a hierarchy of protocols and technologies to address and mange the interference problem using some form of sensing and control mechanisms mainly residing in the WLAN switch and/or the access points. These approaches are non-standardized, and cannot be applied to a multi-vendor scenario. In addition many require costly devices and are not automated form the interference management standpoint (and hence requires IT personnel involvement). In many cases however, the emerging interference problems in WLANs are intermittent and by the time it attracts the IT personnel attention, it may not be present.

WLAN Network Architectures: Today's WLAN architectures have evolved to two major categories, distributed intelligence or centralized intelligence. In a distributed architecture, the intelligence is distributed across the network access points; hence the name “FAT AP”, resulting in more costly but capable access points. In addition, due to their complexity, theses APs are power hungry and as such, can significantly increase the power consumption of larger WLAN networks. A more popular architecture centralizes all the intelligence in one or a few WLAN controllers at the WLAN switch locations, while giving the APs the least intelligence, hence the name “THIN AP”. This architecture has historically been deployed by many vendors and network designers. However the next generation of WLANs architectures and traffic demands of highly dynamic 802.11n-based enterprise WLAN networks which, is less delay tolerant (due to support of the real-time high QoS services) while increasing wireless traffic loads by more than 10 times. A good example of this traffic need is the current trend in the adoption of IP phones (based on Voice or IP), to dramatically reduce the enterprise phone bill. However today's WLAN architectures cannot support voice at enterprise-wide scale. For example, in the popular THIN AP architecture there are usually multi-hops between the AP and the switch. As a result, time-sensitive information and traffic may stay in long queues before getting to the switch. Trying to address this problem, most recently some vendors try to put more intelligence back to the access point, Vendors differ in the level of complexity that is split between the AP and the controller, and in some cases, even regarding what constitutes real time. One of the main strategies of this new approach is to put all or a part of MAC functionalities in the AP, such that time sensitive traffic requirements can be addressed appropriately. Some vendors use an architecture wherein time sensitive part of MAC functionalities are performed at the AP (named FIT AP), while all other functionalities such as management and queuing/scheduling, authentication, association 802.11 frame translation, handover, etc., are handled at a WLAN controller/switch. Others suggest suggests putting even more intelligence in the AP (e.g. packet forwarding, QoS, etc.), leaving a small portion of backbone traffic load to the controller. While trying to address the real-time traffic demands, this approach puts the cost and complexity burden back to the access point. In addition there are two other reasons that makes the FIT AP approach costly and power hungry, and as such not attractive:
a. Firstly, to address the peak traffic demand and overcome the interference the enterprise networks use a high degree of redundancy and multiple layers of access points in their coverage area. Therefore the cost of upgrading from the simple THIN AP to the more sophisticated FIT AP concept can be significant, when there is a large number of APs. Also the power consumption is increased per FIT AP (over THIN AP) and this can add-up to a substantial amount of power waste in large WLANs (not only due to the large redundancy in APs, but also due to the power increase in APs).
b. Secondly, to address the interference problem the interference oriented RF spectrum sensing technologies leaning on the FIT AP concept are evolving. More specifically, since the switch/appliance cannot physically be where the AP is located, some vendors suggest moving the task of monitoring to the AP. That is, use access points that scan (monitor) the air and report the conditions of the environment of the AP up to the switch/appliance. This approach results in adding more complexity, cost and power consumption to the access point, while causing throughput reductions (due to the time the AP refrains from communication to sense the environment).

### SUMMARY OF THE INVENTION

We anticipate that in the absence of some form of interference management, the interference level (including co-channel interference, adjacent channel interference, co-location interference, etc.) can reach to unmanageable levels that can seriously jeopardize the targeted network performance and coverage. Control of interference is also very important to the network designers and service providers as it determines the size and number of access points in the network, which in turn affects the overall network deployment costs and provision of QoS

In one aspect of this invention, the performance enhancement and interference mitigation in wireless networks such as WLANs, and Picocell and Femtocell architectures in cellular networks is addressed by introducing a new centralized surveillance apparatus and/or node concept. The intention is to address the root-cause of interference problem in a costly cost and power efficient way. In addition to the performance enhancement of Picocell and Femtocell deployed in the licensed bands, some aspects of the apparatus introduced herein, are particularly targeted at the unlicensed band-based networks such as Picocells and Femtocells implemented in the WLAN bands and the WLAN system in general. In some embodiments this apparatus enables enhancing and complementing the IEEE 802.11 standards (such as 802.11g, 802.11n, 802.11k and 802.11v) by extending their capabilities towards powerful global algorithms including interference mitigation strategies (both uncoordinated and coordinated co-channel and adjacent channel interferences), thought usage of a dedicated node termed interference controller node or ICN. In one aspect of this invention, the task of the ICN is to continuously scan the environment and report the interference to a centralized network facility such as switch/controller, the network management server and/or access point. In some embodiments other problematic events such as coverage holes and/or rouge APs are communicated to a centralized network facility such as switch/controller, the network management server and/or access point. In some embodiments, the centralized network control mechanisms (such as switch, controller and network management system) in turn use this information in coordination with cells towards optimized algorithms including but not limited to the interference that performs global (or inter-cell) optimizations and/or the local (or intra-cell) optimizations. This information is primarily used to address the interference problem using coordinated inter-cell and intra-cell interference mitigation algorithms. In some embodiments, RF environment footprint is captured in real-time, which enables the APs, controllers, and/or switches to use much more powerful performance enhancement techniques, based on intra-cell coordinated algorithms residing in their access points, controllers or switches. On another embodiment, the real time RF environment footprint is captured, and the ICN node itself performs all or a part of the coordination required for implementation of the global or local performance enhancement algorithms.

### BRIEF DESCRIPTION OF THE FIGURES

The invention described herein, is detailed with reference to the following figures. The attached drawings are provided for purposes of illustration only and only depict examples or typical embodiments of the invention. It should be noted that the illustrated regions are just examples and regions can take any shape. Also, it should be noted although illustrations are shown in 2D; in general, the zones are three dimensional. It also should be noted that for clarity and ease of illustration these drawings are not necessarily made to scale.

FIG. 1 shows the Co-located Interference Report Element Frame Architecture in IEEE 802.11v.

FIG. 2 shows connectivity of the ICN apparatus defined in this invention to a Stand-alone WLAN Architecture Example.

FIG. 3 illustrates connectivity of the ICN apparatus defined in this invention to a Centralized WLAN Architecture.

FIG. 4 illustrates the scalable incorporation of the ICN apparatus defined in this invention to a Semi-Centralized, large scale WLAN Structure.

FIG. 5 illustrates the connectivity of the ICN apparatus defined in this invention to a Wireless Home Network.

### DETAILED DESCRIPTION OF THE INVENTION

In one aspect of this invention, a new node concept defined as the ICN or interference controller node that can be incorporated to the WLAN and/or Picocellular and Femtocellular architectures in cellular systems is introduced. In some embodiments, this node acts as the “eyes” and “ears” of the Controller, Switch, Network Management System and/or Access Points (or excusive combination of the above) and provides them with useful real time information about the RF spectrum and/or channel conditions of different cells. In one embodiment, the location of interfering and/or interfered (victim) nodes are determined and communicated back to the Controller, Switch, Network Management System and/or Access Points (or excusive combination of the above). In some embodiments a simple, yet effective interference coordination and interference mitigation approach, based on a directional RF spectrum sensing mechanism, that can be used with different WLAN architectures as a complementary technology, and does not have the current technological drawbacks is introduced. In one aspect of this invention, targeted applications include all of the WLAN applications as well as the Picocell and Femtocell architectures that use licensed or unlicensed bands for their wireless communications. Some embodiments are based on the centralized RF management concept enabling switch/appliance AP-level visibility, without putting the burden of spectral monitoring to the AP. One aspect of this invention is to provide the switch and APs, including smart APs with real time knowledge of its service area including the RF interference characteristics, such that a number of centralized interference mitigation and coordination methodologies can be used by the network. In some embodiments, using a single dedicated node termed Interference Controller Node or ICN¹, the switch (and the AP) obtains all the information needed to handle the real-time RF management, as well as implementing powerful inter-AP optimization algorithms. This is achieved by the ICN's careful examination and monitoring the radio channels in each AP's coverage area for WLAN and non-WLAN interferences, as well as other disturbances (such as Rouge AP), coverage holes, etc. Some embodiments use an ultra sensitive radio with narrow beam steering, so that the ICN gathers an accurate real-time RF image of the network and communicates it directly to the switch or controller utility (and/or intelligent APs). In some embodiments, client performance related parameters such as packet error rates are monitored and communicate to the infrastructure. One aspect of this invention uses the knowledge of interference location, statistics, etc. available to the L2 and L3, to significantly empower the network management and switch visibility enabling strategies for performance enhancements, and reduction in power consumption at a lower cost. It is noted that, this is achieved by minimal traffic burden on the network and only using a central node (rather than a collection of access points, or RF sensors) or a collection of central node for the whole network. Consequently, unlike portable RF sensor technologies which require IT involvement, one aspect of this invention provides an automated, centralized, and dynamic interference mitigation and coordination platform, and at the same time, avoids the cost and complexity of RF sensing per access point. It is important to note that in some embodiments, while listening wirelessly, the ICN communication with the switch (or APs) and management system is predominately over the wired distribution system (DS) (hence, avoiding introduction of traffic load and interference in the wireless LAN network). ¹Note that each ICN can be associated with a group of APs connected to the same switch, but there may be more than one ICN connected to the switch.

It is important to emphasize that although examples of the algorithms and standards mentioned herein are based on the WLAN, the apparatus and network architectures and methodologies introduced herein can be applied to Picocells and Femotcells as part of the cellular system architectures.

In addition to the capability of enabling switch/controller with detailed knowledge of its environment, in some embodiments, the ICN is capable of locally supporting the processing and signaling required for coordinated intra-cell interference management, and communicates directly over the DS to the APs and network management platforms (For example when the switch has limited capabilities or is only accessible though multiple hops which could delay its access to real-time information).

Achievable Enhancements and Features of the invention: The following categorizes some of the advantages of some aspects of this invention from different views of performance and network deployment:

Enabler of Global Coordination Schemes resulting in significant improvement in the throughput and QoS: In some embodiments, the centralized RF scanning technology therein can communicate a number of useful parameters to the switch/controller over the distribution system, enabling implementation of different inter-cell coordinated algorithms. Examples of such enhancement include:
1) Enabling Deployment of Adaptive, Automated, and Centralized Interference Mitigation: Through coordination with both interferer and the victim node, in one aspect of this invention, the real time interference data provided by ICN enables the centralized controller of the switch to implement a hierarchy of different coordinated interference mitigation techniques. These techniques can provide an extremely flexible and powerful interference mitigation strategy though a centralized coordination function that controls usage of radio resources in time, frequency and spatial domains to minimize inter-cell interference and avoid or overcome uncoordinated or non-WLAN interferers.
ii) Enhancement of Load-Balancing: In one embodiment, the ICN facilitates an enhanced real-time load-balancing capability at the switch by enabling adaptation of the load association according to a real-time network global interference perspective, among other global parameters. For example the switch can decide to re-associate a client with demanding traffic from an interference-hit AP to another AP within the client's reach.
iii) Enhancement of the QoS Support: Real-time traffic handling, and optimization of the QoS support is achieved in some embodiments by enhancing the system-wide rules pertaining the QoS through global knowledge of interference among other parameters (such as priority, source, destination, protocol type, etc.).
iv) Enabling Distributed Power Control: In some embodiments using a real-time and predictable global perspective, moving beyond the intra-AP power control is achievable. This enables transmit power management and optimization to and from a client, from network inter-AP macro diversity perspective. In some embodiments, this global scheme paves the way for a high flexibly by defining several distributed power control scheduling algorithms optimized for aggregate network throughput, cell-edge client throughputs, etc.
v) Enabling Cross-Layer MAC/PHY Optimization with Adaptive Scheduling: By updating the scheduler with real-time interference power and statistics information (e.g. interference period and center frequency), in one aspect of this invention, the MAC scheduling per AP can be optimized to address the global interference and channel condition scenarios. In this regards the so called Multi-User Diversity (MUD) can be exploited to the fullest extent in the MAC scheduler.
vi) Enabling Adaptive Fractional Frequency Reuse (AFFR): Adaptive fractional frequency reuse has shown significant improvement in inter-cell interference mitigation², within the MIMO-based, next generation cellular technology (LTE or long-term evolution). For example, in one embodiment, with the information provided by ICN, the AFFR scheme can be deployed in 802.11n-enabled APs when using a pair of 20 MHz channels. ² The Adaptive Fractional Frequency Reuse, significantly improves the SNIR by adapting fractional frequency reuse assignments based on interference levels, as well as scheduling users with s channel quality measurement fed back from the client

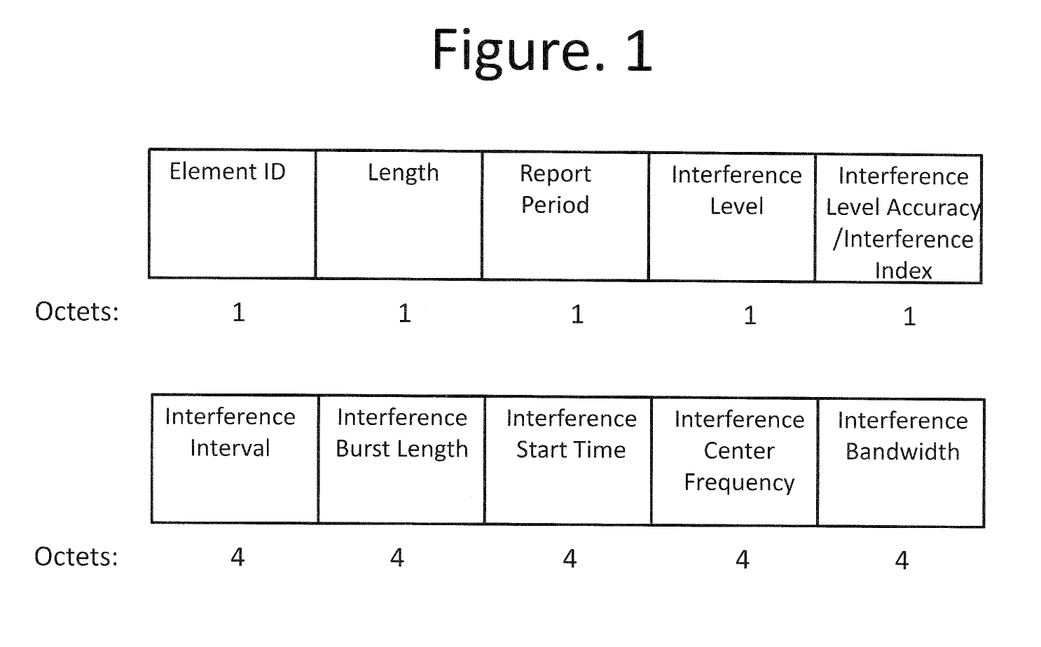

ICN Extension of 802.11v Assisting Greener WLAN Solutions to Interference Problem: In one aspect of the invention, to enhance communication of the real-time RF management information, the recent emerging Wireless Network Management standard, IEEE 802.11v is supported by the ICN. Among its many benefits the 802.11v protocols facilitates extensive communication of the client specific RF management parameters to the switch and the (enterprise) management system for a more accurate and adaptive network control and management. Examples of these communications facilitated by an 802.11v enabled ICN include:
i) Enforcing Power Management Features on the 802.11v Enabled Terminals: In several embodiments different 802.11v power management features or their combination is supported by the ICN. This particularly helps with the networks that the serving AP is not 802.11v enabled. Examples include Proxy ARP (that will let the ICN respond to ARP requests enabling stations to power down for longer periods) and the WNM (Wireless Network Management) sleep mode that let clients conserve power by turning their radios off more frequently (see Reference [3], which is incorporated herein by reference in its entirety). This feature drastically improves the battery life of mobile devices and may also lower the energy draw from access points. An example scenario applicable to enterprise WLAN is an 802.11v-enabled smartphone that could lower power to its wireless radio when it's inactive, then power back up to take a VoIP call or receive a new e-mail. In addition, in some embodiments, through 802.11v protocols, inactive APs could run on minimal consumed power and switch back to full power when wireless clients are detected (again this can be coordinated through the ICN in the absence of 802.11v-enabled APs).
ii) Transmission of Detailed Information on Co-location Interference: In some embodiments when a multi-interface terminal supports the 802.11v protocol, but the serving AP is not upgraded to support 802.11v, the ICN can receive the detail information on co-located interferers (wirelessly) and communicate it to the MAC scheduler in the Switch/Controller (or the smart AP) through the wired network. This is facilitated by 802.11v “Collocated Interference Report Elements”. Each Collocated Interference Report Element contains some characteristics of the reported collocated interference. The Collocated Interference Report element includes interference level, its center-frequency, timing and period (if periodic), and other useful information as defined in FIG. 1. Note the Element ID field for Collocated Interference Report value is defined as in pp. 96, Table 7-26, of (see Reference [3], which is incorporated herein by reference in its entirety).
iii) Transmission of Detailed Information on Co-channel Interference: In some embodiments, irrespective of the AP's support of 802.11v protocols, the ICN transmits the co-channel interference information using a report element with architecture similar to the co-located interference report element, but with a different element ID. Any element ID from the reserved range (i.e., element IDs between 101 and 220, may be used. (according to Table 7-26 in (see Reference [3], which is incorporated herein by reference in its entirety)). In some embodiments, if the victim node is not co-located with interferers, the Collocated Interference Report Element of FIG. 1 is used to report for co-channel interference.
iv) Transmission of Detailed Information on Adjacent-channel Interference: In some embodiments when adjacent channel interferers are present, the interference information is coordinated by the ICN through a report element with architecture similar to the co-channel interference report element, but with a different element ID.
v) Usage of Real-Time Location Services (RTLS) to Enhance RF Management and Interference Mitigation. The IEEE802.11v's RTLS technology accommodates high-level wireless client tracking. This enables a WLAN to redirect a client to another nearest access point if the serving one is overloaded. RTLS also provides for new location-based services and applications by letting network administrators compile network performance data from clients themselves. In some embodiments this capability is used towards a centralize interference mitigation scheme that benefits from location information of the clients and APs to detect, analyze and address the interference scenarios. In this regards, the RTLS can provide an accurate RF image of the network required for an effective coordinated interference mitigation strategy. For example, in one aspect of the invention, the knowledge of client location through the RTLS can help with intra AP and inter AP adaptive, coordinated beam forming schemes to maximize the coverage while minimizing the interference effects.
vi) In some embodiment a location strategy for non-WLAN and rouge AP nodes is used. This location strategy provides triangulation using the direction (angle) of the interference with respect to the ICN in conjunction with the knowledge of the location of victim AP and the ICN to locate the interfere. In some embodiments the above information is used in conjunction to the received interference power to locate the interferer. In particular, the received interference powers at the AP and the ICN, from which an estimate of the distance between the interfere and the AP and the interfere and the ICN is derived respectively. Another embodiment uses the same triangulation strategy using the direction (angle) of the interference with respect to the ICN in conjunction with the knowledge of the location of victim AP and the ICN, but employs a time of arrival approach to determine the interferer distance to the AP and the ICN respectively, to locate the interference source.
vii) In some embodiments a combination of the schemes mentioned in v) and vi) above is used to locate both WLAN and non-WLAN interferes including rouge APs.
viii) Reduction of the Network Power Consumption though Centralized Interference Mitigation In addition to the power reduction facilitated through the 802.11v, in some embodiments, the interference mitigation strategy based on the centralized ICN concept (the may deploy the 802.11v-based RTLS) inherently reduces the overall network power consumption by either or a combination of the following:
   (a) Mitigation of retransmissions due to collision
   (b) Turing off the unused APs in redundant networks
   (c) Lifting the need for per-AP interference detection and mitigation, hence saving the AP power consumption.

Example Scenarios: The following gives examples of different network scenarios that can benefit from the apparatus in this invention:

(a) Scalable Solution that can be Incorporated to a Variety of Enterprise Network Deployment Scenarios: In one aspect of the invention the solution therein can complement different standardize deployment scenario ranging from stand-alone architectures with FAT AP's to centralized architectures with THIN APs, as well as semi-distributed architectures supported by the new FIT AP concept (also known as Intelligent APs). In some embodiments, this communication enables the access points and switch in coordination with network management application to deploy a number of performance enhancement and interference mitigation algorithms such as power control, MAC parameter adjustment, load balancing, beam forming, MIMO, etc. which can be performed locally (per access point) or globally (per network), (for example see Reference [4], which is incorporated herein by reference in its entirety or see Reference [5], which is incorporated herein by reference in its entirety).

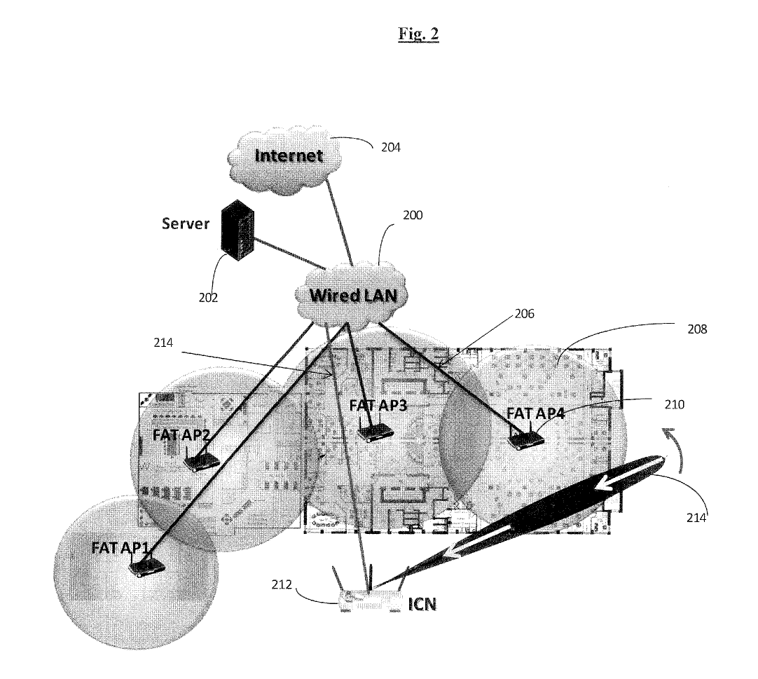

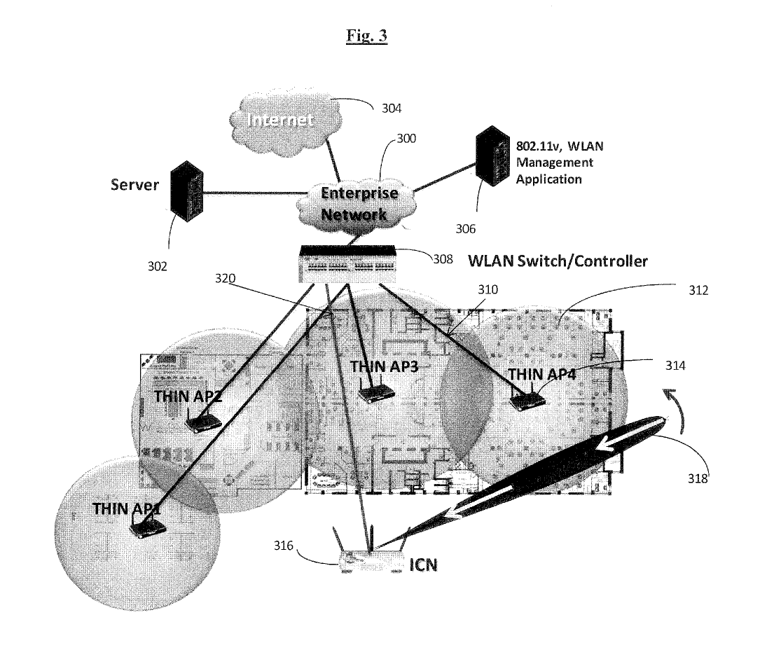

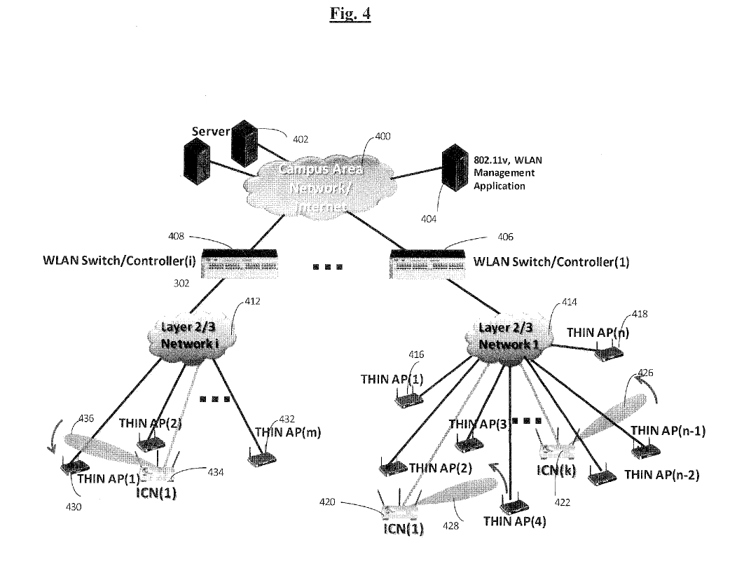

The following highlights some example scenarios:
i) Stand-alone or Autonomous Architecture: The Stand-alone also known as Autonomous architecture was popular in early enterprise WLAN deployments. Referring to FIG. 2, this architecture requires sophisticated APs 210 that completely implement and locally terminate all of the 802.11 functionalities while providing communications to the server through the 802.3 frames on the wired LAN 206. The access point in such a network is referred to as FAT AP. Support of these types of networks is achieved by direct communications with each AP through the wired network 200. Since in this arrangement each AP can be viewed as a separate network entity on the network which is independently managed, it gains limited benefit from the ICN apparatus 212 which in some embodiments enables some of the coordinated approaches mentioned above. However, in some embodiments, some level of interference management and scheduling information can still be communicated to each AP to maximize its interference mitigation capabilities in several dimensions including beam forming and MIMO (spatial domain), channel switching (frequency domain) and scheduling (spatial and time domain). In addition, one embodiment uses an indirect inter-cell coordination scheme managed by the ICN 212 or by the network management application 202 through ICN. In some embodiments, beam forming can be coordinated across the cells to minimize inter-cell interference. FIG. 2, illustrates the ICN 212 connectivity to the network. This figure gives an example of some embodiments that use a beam steering or beam switching receiving ICN with the receiver antenna beam 214 is rotating, or switching between different locations, to cover the whole service area of the ICN 212.
ii) Centralized Architecture: Centralized architectures are very common in WLAN deployments due to a number of benefits they provide. Also known as “Overlay Architecture”, the centralized concept effectively creates a specific network that is dedicated to wireless users. Referring to FIG. 3, it is composed of WLAN switches 308 interconnected with THIN APs 314 over Ethernet cabling 310. The level of intelligence in THIN AP 314 can vary from simply being a radio interface supporting PHY activities to performing partial MAC or full MAC operations. In the thinnest AP scenario, the system-wide intelligence is centralized into a single (or multiple) switch/appliance setup centralizing all functionalities including QoS, traffic forwarding, and encryption, in addition to policy creation such that all of MAC and upper layer functionalities that also take place within the switch (or controller appliance). On the other hand, the “Partial MAC” scenario splits MAC operation between the switch 308 and thin access points 314 such that the AP pertains to the MAC functionalities that require real-time processing (such as transmission of beacon frames, traffic forwarding, probe request and L2 encryption). All other functionalities that are not time-sensitive such as authentication, association, 802.11 frame translation, and handover including packet classification and QoS, are performed at the Switch 308. Some thin access points perform complete IEEE 802.11 MAC layer and PHY layer processing. In this case the Switch performs support of authentication and security. In some embodiments as illustrated in the example in FIG. 3, a deployment scenario where the ICN 316 is directly connected to the switch through wired connection 310. This figure gives an example of a beam steering or beam switching receiving ICN with the receiver antenna beam 318 is rotating, or switching between different locations, to cover the whole service area of the ICN 316
iii) Scalable Solution for Larger Networks: Referring to FIG. 4, for larger networks such as campus area 400 with a semi-centralized architecture (consisting multitude of centralized WLAN Switch/Controllers 406, 408) a number of ICNs may be used in some embodiments. FIG. 4 illustrates a setup that associates a group of ICNs with a switch (e.g. 422 and 428 associated with 406) for multitudes of layer 2/layer 3 networks (e.g. 414). As can be seen the management agent is operating from a centralized location of 404.

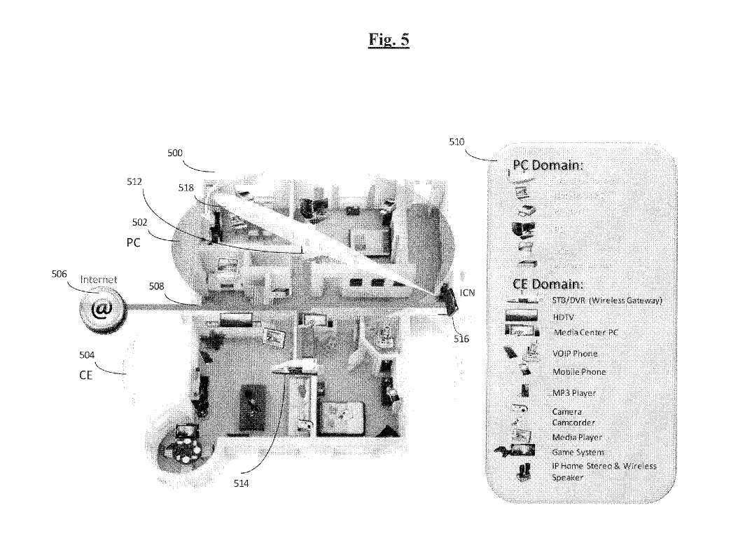

(b) Scalable Solution that can be Incorporated to Home WLAN Network Deployment Scenarios: FIG. 5 illustrates an example deployment scenario referring to an aspect of the invention where the ICN 516 is directly connected to the wired connection home infrastructure network or point of entry 508. The home network 500 is an example network composed of PC domain network 502 and/or consumer electronic domain (CE domain) network 504. Each network is has an access point, 512 and 514 respectively, where 514 can be a wireless gateway and/or a combination a wireless STB (set top box) or its combination with a DVR (digital video recorder), and. It is noted that either or both the networks 502, and 504 or an overlaid combination of the two defined as a signal PC and CE capable home network can be supported. The home network can serve any wireless terminal examples of which are illustrated and listed in 510. This figure gives an example of a beam steering or beam switching receiving ICN with the receiver antenna beam 518 is rotating, or switching between different locations, to cover the whole service area of the ICN 516. In some embodiments, the ICN communicate the information regarding location, frequency and statistic related to problematic nodes (e.g. power, duty cycle, etc.) to the access points 512 and 514. The communication is mainly done over the wired network 508 such as Ethernet, Cable, etc. that connects the Internet 506 to the access points, using the protocol(s) understandable by the access points. In some Embodiments this information pertains to either or both of the interferer node(s) and interfered (victim) node(s). This information helps the access points to deploy a number of performance enhancement and interference mitigation algorithms such as power control, MAC parameter adjustment, load balancing, beam forming, MIMO, etc. which can be performed locally (per access point) or globally (per network), (for example see Reference [4], which is incorporated herein by reference in its entirety or see Reference [5], which is incorporated herein by reference in its entirety).

It will be recognized that while certain aspects of the invention are described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

### APPENDIX I

### References

Each of the following references is incorporated herein by reference in its entirety.

[1] Part 11: Wireless LAN Medium Access Control (MAC) and Physical Layer (PHY) specifications, Amendment 8: Medium Access Control (MAC) Quality of Service Enhancements (IEEE 802.11e standard).

[2] Local and metropolitan area networks—Specific requirements Part 11: Wireless LAN Medium Access Control (MAC) and Physical Layer (PHY) Specifications Amendment 1: Radio Resource Measurement of Wireless LANs (802.11k), Supplement to 802.11-2007.

[3] IEEE 802.11v./D6.01, Part 11: Wireless LAN Medium Access Control (MAC) and Physical Layer (PHY) specifications, Amendment 8: Wireless Network Management (IEEE 802.11v standard draft).

[4] Saied Safavi, Application No. 61/224,830 titled “Centralized cross-layer method and apparatus for interference mitigation in a wireless network,” filed on Jul. 10, 2009.

[5] Saied Safavi, Application No. 61/252,008 titled “Method and apparatus for centralized and coordinated interference mitigation in a WLAN network,” filed Oct. 15, 2009.

What is claimed:

1. An RF interference surveillance node architecture for use in one or more wireless networks, comprising:
an interference coordinator node (ICN) configured to detect and/or mitigate one or more interferers and/or other sources of performance degradation.

2. The architecture of claim 1, further comprising a narrow beam antenna array configured to perform beam forming, beam steering, and/or MIMO to determine one or more statistics of an interference source.

3. The architecture of claim 2, wherein the determination of the one or more statistics are based on at least one of the following:
i) one or more detected characteristics of the interference source:
ii) signaling information exchange with the interference source; and/or
iii) signaling information exchange with an interfered or victim node.

4. The architecture of claim 1, further comprising a coordination mechanism that enables at least a portion of information obtained by said ICN to be communicated to at least one of the following:
i) a network switch;
ii) a network controller;
iii) a network management utility; and/or
iv) access points and/or base stations.

5. The architecture of claim 1, wherein the one or more networks comprises a Wireless LAN (WLAN) network.

6. The architecture of claim 1, wherein the one or more networks comprises a Picocell or femtocell Network operative in unlicensed bands acting as a part of a cellular network.

7. The architecture of claim 1, wherein the one or more networks comprises a Picocell or femtocell Network in licensed bands acting as a part of a cellular network.

8. The architecture of claim 1, wherein the one or more networks support at least one of the IEEE 802.11k standards and/or IEEE 802.11v standards.

9. The architecture of claim 11, further comprising a node that communicates co-location interference to one or more nodes of the one or more networks nodes through usage of a co-located interference report element frame architecture.

10. The architecture of claim 11, wherein the node is equipped with the an enhancement to the IEEE 802.11v protocols that can perform centralized co-channel interference management through communication with a centralized facility including switch/controller, network management utility, and/or access points over the infrastructure network, the co-channel interference being communicated to the network nodes and supporting infrastructure through usage of the Co-located Interference Report Element Frame Architecture.

11. A method of operating a wireless network, comprising:
detecting one or more interference sources at a substantially centralized node of said network; and
distributing information relating to said detected one or more interference sources to one or more second nodes.

12. The method of claim 11, wherein said distributing is performed so that said one or more second nodes may mitigate the effect of said detected one or more sources on said one or more second nodes.

13. The method of claim 11, further comprising a second network, and said one or more second nodes are disposed in said second network, and said distributing is performed so that said one or more second nodes may mitigate the effect of said detected one or more sources on said one or more second nodes.

14. Apparatus for use a wireless network, comprising:
first apparatus configured to monitor at least a portion of an RF spectrum used by said network, and detect one or more interference sources; and
second apparatus configured to distribute information relating to said detected one or more interference sources to one or more nodes.

15. The apparatus of claim 14, wherein the apparatus is disposed at a substantially centralized location within said network, and further a narrow beam antenna array configured to perform beam forming, beam steering, and/or MIMO to determine one or more statistics of said one or more interference sources.
